(19) United States
(12) Patent Application Publication
(10) Pub. No.: US 2021/0306802 A1
(43) Pub. Date: Sep. 30, 2021

(54) POSITION ESTIMATION DEVICE, POSITION ESTIMATION SYSTEM, AND POSITION ESTIMATION METHOD

(71) Applicant: TOSHIBA TEC KABUSHIKI KAISHA, Tokyo (JP)

(72) Inventors: Yu Yoshiie, Yokohama Kanagawa (JP); Yasuhiro Kinoshita, Tama Tokyo (JP); Mika Hirama, Kokubunji Tokyo (JP)

(21) Appl. No.: 16/951,034

(22) Filed: Nov. 18, 2020

(30) Foreign Application Priority Data
Mar. 24, 2020 (JP) 2020-053054

(51) Int. Cl. H04W 4/029; H04W 4/02; H04W 4/40; H04W 4/50

(52) U.S. Cl. CPC H04W 4/029; H04W 4/50; H04W 4/40; H04W 4/027

(57) ABSTRACT

According to one embodiment, a position estimation device includes a first acquisition unit, a determination unit, and an estimation unit. The first acquisition unit acquires a first position of a moving body. The determination unit determines that direct wireless communication is possible between a terminal device and a communication device riding on the moving body. When the direct communication is possible, the estimation unit regards a position of the moving body as a position of the terminal device.

### CROSS-REFERENCE TO RELATED APPLICATION

This application is based upon and claims the benefit of priority from Japanese Patent Application No. 2020-053054, filed on Mar. 24, 2020, the entire contents of which are incorporated herein by reference.

### FIELD

Embodiments described herein relate generally to a position estimation device, a position estimation system, and a position estimation method.

### BACKGROUND

There is a technique called pedestrian dead reckoning (PDR) as a technique for estimating a position of a pedestrian using various sensors such as an acceleration sensor and an angular velocity sensor. As the PDR is specialized in estimating the position of a pedestrian, the position estimation may not be successful when a pedestrian moves riding on a moving body.

### DESCRIPTION OF THE DRAWINGS

FIG. 1 is a diagram for illustrating the outline of a position estimation system according to an embodiment;

FIG. 2 is a block diagram showing an example of a circuit configuration of a main part of the positioning server in FIG. 1;

FIG. 3 is a block diagram showing an example of a circuit configuration of a main part of the mobile terminal device in FIG. 1;

FIG. 4 is a block diagram showing an example of a circuit configuration of a main part of the moving body terminal device in FIG. 1;

FIG. 5 is a block diagram showing an example of a circuit configuration of a main part of the beacon in FIG. 1;

FIG. 6 is a flowchart showing an example of processing according to the embodiment by the processor of the positioning server in FIG. 2;

FIG. 7 is a flowchart showing an example of processing according to the embodiment by the processor of the positioning server in FIG. 2;

FIG. 8 is a flowchart showing an example of processing according to the embodiment by the processor of the positioning server in FIG. 2;

FIG. 9 is a diagram showing an example of a table stored in the auxiliary storage device in FIG. 2;

FIG. 10 is a diagram showing an example of a table stored in the auxiliary storage device in FIG. 2;

FIG. 11 is a diagram showing an example of a table stored in the auxiliary storage device in FIG. 2; and

FIG. 12 is a diagram showing an example of a table stored in the auxiliary storage device in FIG. 2.

### DETAILED DESCRIPTION

The problem to be solved by the embodiments of the present disclosure is to provide a position estimation device, a position estimation system, and a position estimation method capable of estimating a position of a pedestrian while the pedestrian is riding on a moving body.

In general, according to one embodiment, the position estimation device includes a first acquisition unit, a determination unit, and an estimation unit. The first acquisition unit acquires a first position of a moving body. The determination unit determines that direct wireless communication is possible between a terminal device and a communication device riding on the moving body. When the direct communication is possible, the estimation unit considers a position of the moving body a position of the terminal device.

Hereinafter, a position estimation system according to the embodiments will be described with reference to the drawings. In the drawings used for the description of the embodiments below, the scale of each unit may be changed as appropriate. The drawings used for the description of the following embodiments may be illustrated with the configuration omitted for the sake of description. In the drawings and the present specification, the same reference numerals denote the same elements.

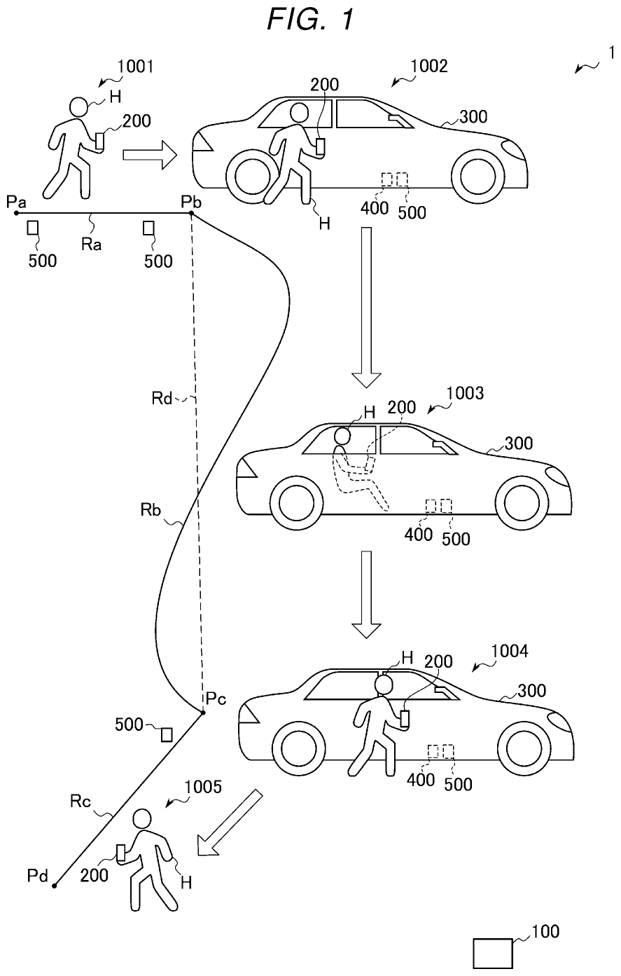

FIG. 1 is a diagram for illustrating the outline of a position estimation system 1 according to the embodiment. The position estimation system 1 includes, for example, a positioning server 100, a mobile terminal device 200, a moving body 300, a moving body terminal device 400, and a beacon 500. The position estimation system 1 typically includes a plurality of mobile terminal devices 200, moving bodies 300, moving body terminal devices 400, and beacons 500, respectively. The position estimation system 1 also includes one or more positioning servers 100.

The positioning server 100 communicates with the mobile terminal device 200, the moving body terminal device 400, and the like to acquire information regarding the positions of the mobile terminal device 200 and the moving body terminal device 400. Then, the positioning server 100 estimates a position of the mobile terminal device 200. The positioning server 100 is an example of a position estimation device.

A pedestrian H carries the mobile terminal device 200. Therefore, a position of the pedestrian H is the position of the mobile terminal device 200.

The mobile terminal device 200 acquires information necessary for estimating the position of the pedestrian H by PDR. In the PDR, for example, the moving distance and the position of the pedestrian H are estimated by detecting a walking motion (such as steps) of the pedestrian H and estimating the step length. The mobile terminal device 200 and the moving body terminal device 400 have a terminal ID (identifier). The terminal ID is identification information uniquely given to each of the mobile terminal device 200 and the moving body terminal device 400. The mobile terminal device 200 is an example of a terminal device. The mobile terminal device 200 is also an example of a first terminal device. The terminal ID of the moving body terminal device 400 is an example of second identification information that identifies the moving body terminal device 400.

The moving body 300 is a vehicle that can be moved with a pedestrian H thereon. The moving body 300 is, for example, a car, a ship, or an aircraft. The moving body 300 may be manned driving or unmanned driving one. The moving body 300 includes the moving body terminal device 400 and the beacon 500.

The moving body terminal device 400 estimates the position of the mobile body 300 by dead reckoning (DR) such as cart dead reckoning (CDR) or a global navigation satellite system (GNSS) such as a global positioning system (GPS). The moving body terminal device 400 is an example of a second terminal device.

The beacon 500 has a beacon ID. The beacon 500 transmits a radio wave including the beacon ID. The radio wave transmitted by the beacon 500 is hereinafter referred to as a “beacon radio wave”. The beacon 500 is an example of a communication device.

The position estimation system 1 can identify the moving body 300 where the mobile terminal device 200 is on by the mobile terminal device 200 receiving the beacon ID. This is because if the mobile terminal device 200 can receive the beacon radio wave, it means that the mobile terminal device 200 is near the beacon 500 that is the transmission source of the beacon radio wave. The beacon ID is identification information uniquely assigned to each of the beacon 500. The beacon ID is an example of first identification information.

The beacon 500 is also installed in a passage or a road on which the pedestrian H walks. Such a beacon 500 is installed for the purpose of correcting position estimation of the pedestrian H by PDR.

FIG. 1 shows the movement of the pedestrian H in steps 1001 to 1005. The pedestrian H walks from a point Pa to a point Pb, moves from the point Pb to a point Pc while riding on the moving body 300, and walks from the point Pc to a point Pd.

Step 1001 shows that the pedestrian H moves on the route Ra from the point Pa to the point Pb by walking.

Step 1002 shows that the pedestrian H gets on the moving body 300 at the point Pb.

Step 1003 shows the pedestrian H moves on the route Rb from the point Pb to the point Pc in a state of riding on the moving body 300.

Step 1004 shows that the pedestrian H gets off the moving body 300 at the point Pc.

Step 1005 shows that the pedestrian H moves on the route Rc from the point Pc to the point Pd by walking.

The position estimation system 1 estimates the position of the pedestrian H using the mobile terminal device 200 while the pedestrian H is walking. That is, the position estimation system 1 estimates the position of the pedestrian H using the mobile terminal device 200 on the route Ra and the route Rc.

Then, the position estimation system 1 considers the position of the moving body 300 the position of the pedestrian H while the pedestrian H is riding on the moving body 300. That is, the position estimation system 1 estimates the position of the pedestrian H using the moving body terminal device 400 on the route Rb.

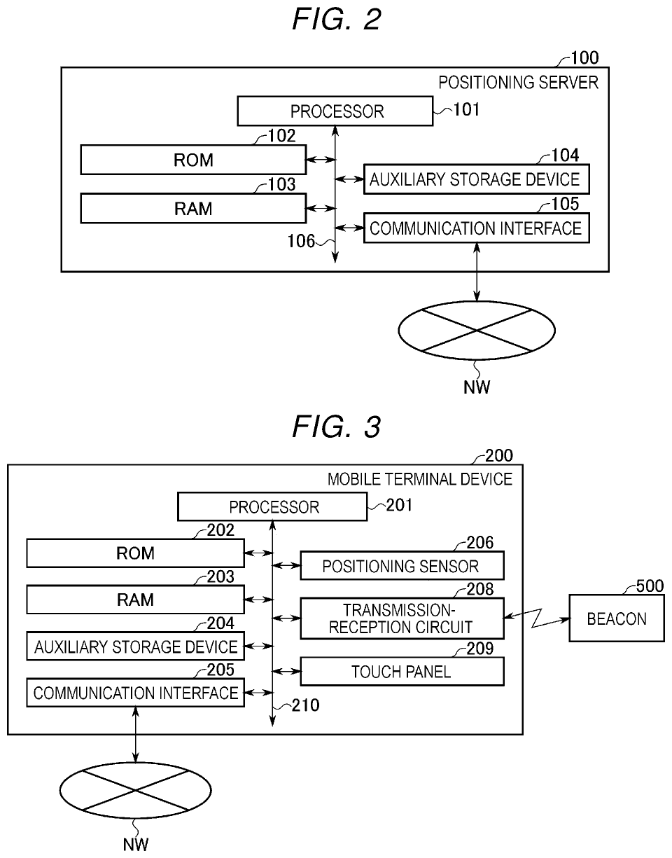

The components included in the position estimation system 1 will be described with reference to FIGS. 2 to 5.

FIG. 2 is a block diagram showing an example of a circuit configuration of a main part of the positioning server 100.

The positioning server 100 includes, for example, a processor 101, a read-only memory (ROM) 102, a random-access memory (RAM) 103, an auxiliary storage device 104, and a communication interface 105. Then, a bus 106 or the like connects these units.

The processor 101 corresponds to the central part of a computer that performs processing such as calculation and control necessary for the operation of the positioning server 100. The processor 101 controls each unit to realize various functions of the positioning server 100 based on programs such as firmware, system software, and application software stored in the ROM 102 or the auxiliary storage device 104. The processor 101 executes the processes described later based on the program. Part or all of the program may be incorporated in the circuit of the processor 101. The processor 101 is, for example, a central processing unit (CPU), a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA). Alternatively, the processor 101 is a combination of a plurality of these.

The ROM 102 corresponds to a main storage device of a computer having the processor 101 as a center. The ROM 102 is a non-volatile memory used exclusively for reading data. The ROM 102 stores, for example, the firmware of the above programs. The ROM 102 also stores data used by the processor 101 in performing various processes.

The RAM 103 corresponds to a main storage device of a computer having the processor 101 as a center. The RAM 103 is a memory used for reading and writing data. The RAM 103 is used as a work area for storing data temporarily used by the processor 101 in performing various processes. The RAM 103 is typically a volatile memory.

The auxiliary storage device 104 corresponds to an auxiliary storage device of a computer having the processor 101 as a center. The auxiliary storage device 104 is, for example, an electric erasable programmable read-only memory (EEPROM), a hard disk drive (HDD), a flash memory, or the like. The auxiliary storage device 104 stores, for example, system software and application software among the above programs. The auxiliary storage device 104 also stores data used by the processor 101 for performing various processes, data generated by the processing in the processor 101, various setting values, and the like. The auxiliary storage device 104 also stores each table described later. Therefore, the auxiliary storage device 104 is an example of a storage unit.

The communication interface 105 is an interface for the positioning server 100 to communicate via the network NW or the like. The communication interface 105 is an example of a third communication unit. The network NW is a communication network including the Internet, for example.

The bus 106 includes a control bus, an address bus, a data bus, and the like, and transmits signals transmitted and received by each unit of the positioning server 100.

FIG. 3 is a block diagram showing an example of a circuit configuration of a main part of the mobile terminal device 200. The mobile terminal device 200 includes, for example, a processor 201, a ROM 202, a RAM 203, an auxiliary storage device 204, a communication interface 205, a positioning sensor 206, a transmission-reception circuit 208, and a touch panel 209. Then, a bus 210 or the like connects these units.

The processor 201 corresponds to the central part of a computer that performs processing such as calculation and control necessary for the operation of the mobile terminal device 200. The processor 201 controls each unit to realize various functions of the mobile terminal device 200 based on programs such as firmware, system software, and application software stored in the ROM 202 or the auxiliary storage device 204. The processor 201 executes the processes described later based on the program. Part or all of the program may be incorporated in the circuit of the processor 201. The processor 201 is, for example, CPU, MPU, SoC, DSP, GPU, ASIC, PLD, FPGA, or the like. Alternatively, the processor 201 is a combination of a plurality of these.

The ROM 202 corresponds to the main storage device of a computer having the processor 201 as a center. The ROM 202 is a non-volatile memory used exclusively for reading data. The ROM 202 stores, for example, the firmware of the above programs. The ROM 202 also stores data used by the processor 201 in performing various processes.

The RAM 203 corresponds to a main storage device of a computer having the processor 201 as a center. The RAM 203 is a memory used for reading and writing data. The RAM 203 is used as a work area for storing data temporarily used by the processor 201 in performing various processes. The RAM 203 is typically a volatile memory.

The auxiliary storage device 204 corresponds to an auxiliary storage device of a computer having the processor 201 as a center. The auxiliary storage device 204 is, for example, EEPROM, HDD, flash memory, or the like. The auxiliary storage device 204 stores, for example, system software and application software among the above programs. The auxiliary storage device 204 stores data used by the processor 201 for performing various processes, data generated by the processing in the processor 201, various setting values, and the like.

The communication interface 205 is an interface for the mobile terminal device 200 to communicate via the network NW or the like. The communication interface 205 includes an antenna and a circuit for wireless communication.

The positioning sensor 206 is a sensor used for positioning the mobile terminal device 200. The positioning sensor 206 is a sensor used for PDR such as an acceleration sensor and an angular velocity sensor. The positioning sensor 206 may also include a magnetic sensor or the like. The positioning sensor 206 outputs sensor information including information obtained by the sensing.

The transmission-reception circuit 208 is a circuit that receives radio waves transmitted from the beacon 500. The transmission-reception circuit 208 includes an antenna or the like for transmitting and receiving radio waves. The transmission-reception circuit 208 may be capable of transmitting radio waves to the beacon 500. The transmission-reception circuit 208 is an example of a reception unit that receives the radio wave transmitted by the beacon 500.

The touch panel 209 is formed by stacking a display such as a liquid crystal display or an organic electro-luminescence (EL) display and a pointing device by touch input. The display included in the touch panel 209 functions as a display device that displays a screen for notifying the operator of the mobile terminal device 200 of various types of information. The touch panel 209 also functions as an input device that receives a touch operation by the operator.

The bus 210 includes a control bus, an address bus, a data bus, and the like, and transmits signals transmitted and received by each unit of the mobile terminal device 200.

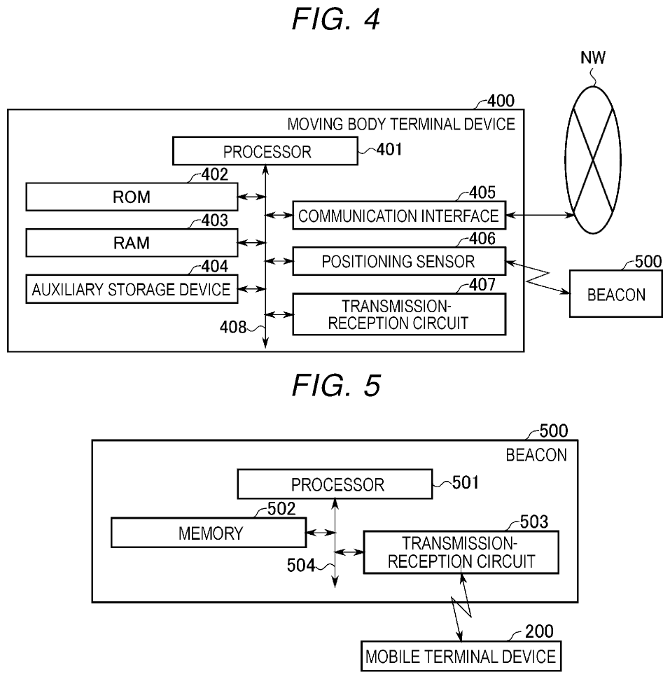

FIG. 4 is a block diagram showing an example of a circuit configuration of a main part of the moving body terminal device 400.

The moving body terminal device 400 includes, for example, a processor 401, a ROM 402, a RAM 403, an auxiliary storage device 404, a communication interface 405, a positioning sensor 406, and a transmission-reception circuit 407. Then, a bus 408 or the like connects these units.

The processor 401 corresponds to a central part of a computer that performs processing such as calculation and control necessary for the operation of the moving body terminal device 400. The processor 401 controls each unit to realize various functions of the moving body terminal device 400 based on programs such as firmware, system software, and application software stored in the ROM 402, or the auxiliary storage device 404. The processor 401 executes the processes described later based on the program. Part or all of the program may be incorporated in the circuit of the processor 401. The processor 401 is, for example, CPU, MPU, SoC, DSP, GPU, ASIC, PLD, FPGA, or the like. Alternatively, the processor 401 is a combination of a plurality of these.

The ROM 402 corresponds to a main storage device of a computer having the processor 401 as a center. The ROM 402 is a non-volatile memory used exclusively for reading data. The ROM 402 stores, for example, the firmware of the above programs. The ROM 402 also stores data used by the processor 401 in performing various processes.

The RAM 403 corresponds to a main storage device of a computer having the processor 401 as a center. The RAM 403 is a memory used for reading and writing data. The RAM 403 is used as a work area for storing data temporarily used by the processor 401 in performing various processes. The RAM 403 is typically a volatile memory.

The auxiliary storage device 404 corresponds to an auxiliary storage device of a computer having the processor 401 as a center. The auxiliary storage device 404 is, for example, EEPROM, HDD, flash memory, or the like. The auxiliary storage device 404 stores, for example, system software and application software among the above programs. The auxiliary storage device 404 stores data used by the processor 401 in performing various processes, data generated by the processing in the processor 401, various setting values, and the like.

The auxiliary storage device 404 stores the terminal ID given to the moving body terminal device 400.

The communication interface 405 is an interface for the moving body 300 to communicate via the network NW or the like.

The positioning sensor 406 is a sensor used for positioning the moving body terminal device 400. The positioning sensor 406 is, for example, an encoder or a sensor used for DR such as an acceleration sensor and an angular velocity sensor. Alternatively, the positioning sensor 406 is an antenna for GNSS such as GPS. The positioning sensor 406 outputs sensor information including information obtained by the sensing.

The transmission-reception circuit 407 is a circuit that receives radio waves transmitted from the beacon 500. The transmission-reception circuit 407 includes an antenna or the like for transmitting and receiving radio waves. The transmission-reception circuit 407 may be capable of transmitting radio waves to the beacon 500.

The bus 408 includes a control bus, an address bus, a data bus, and the like and transmits signals transmitted and received by each unit of the moving body terminal device 400.

FIG. 5 is a block diagram showing an example of a circuit configuration of a main part of the beacon 500.

The beacon 500 includes, for example, a processor 501, a memory 502, and a transmission-reception circuit 503. Then, a bus 504 or the like connects these units.

The processor 501 corresponds to the central part of a computer that performs processing such as calculation and control necessary for the operation of the beacon 500. The processor 501 controls each unit to realize various functions of the beacon 500 based on programs such as firmware, system software, and application software stored in the memory 502 and the like. The processor 501 executes the process described later based on the program. Part or all of the program may be incorporated in the circuit of the processor 501. The processor 501 is, for example, CPU, MPU, SoC, DSP, GPU, ASIC, PLD, FPGA, or the like. Alternatively, the processor 501 is a combination of a plurality of these.

The memory 502 corresponds to a main storage device of a computer having the processor 501 as a center. The memory 502 stores the above program. The memory 502 is also used as a work area for storing data temporarily used by the processor 501 in performing various processes.

The memory 502 stores the terminal ID given to the beacon 500.

The memory 502 of the beacon 500 installed in a passage or a road also stores the coordinates of the installation position.

The transmission-reception circuit 503 is a circuit that periodically transmits radio waves. The transmission-reception circuit 503 includes an antenna or the like for transmitting and receiving radio waves. The radio wave transmitted by the transmission-reception circuit 503 carries information including the beacon ID. The radio wave transmitted by the transmission-reception circuit 503 is based on a standard such as Bluetooth (registered trademark) low energy (BLE). The transmission-reception circuit 503 is an example of a transmission unit that transmits the beacon ID.

The bus 504 includes a control bus, an address bus, a data bus, and the like and transmits signals transmitted and received by each unit of the beacon 500.

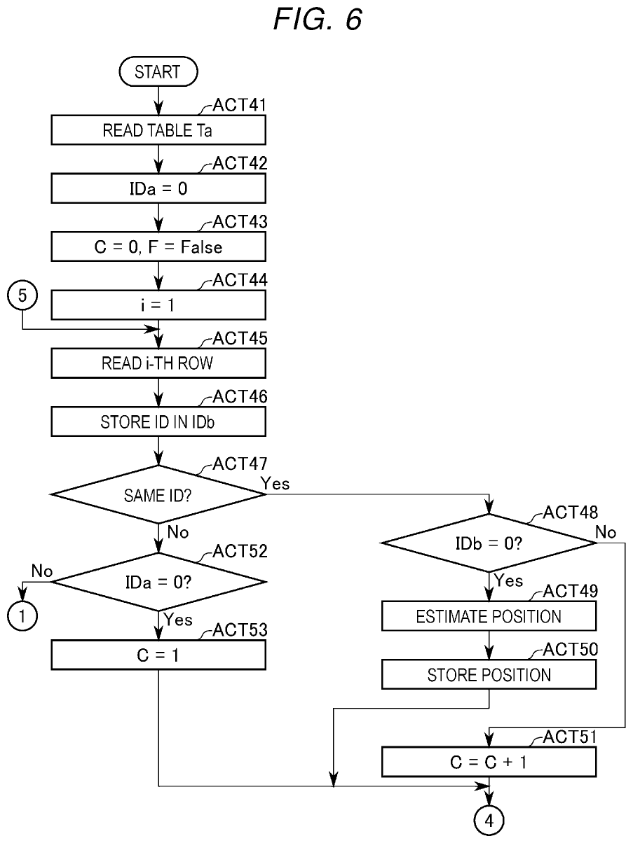

Hereinafter, the operation of the position estimation system 1 according to the embodiment will be described based on FIGS. 6 to 8. The content of the processing in the following description of the operation is an example and various processes capable of obtaining the same result can be appropriately used. FIGS. 6 to 8 are flowcharts showing an example of the processing by the processor 101 of the positioning server 100. The processor 101 executes the processing of FIGS. 6 to 8 based on a program stored in the ROM 102 or the auxiliary storage device 104, for example.

The processor 201 of the mobile terminal device 200 acquires sensor information from the positioning sensor 206 and attempts to receive the beacon radio waves, for example, once every predetermined time Ua. The sensor information is, for example, acceleration and angular velocity of the mobile terminal device 200.

When the processor 201 successfully received a beacon radio wave, the processor 201 generates first mobile position information. The first mobile position information includes the current time, the terminal ID of the mobile terminal device 200, the acquired sensor information, and the beacon ID included in the beacon radio wave. On the other hand, when the processor 201 failed to receive the beacon radio wave, the processor 201 generates second mobile position information. The second mobile position information includes the current time, the terminal ID of the mobile terminal device 200, the acquired sensor information, and the beacon ID indicating that the beacon radio wave is not received. The beacon ID indicating that the beacon radio wave is not received is a predetermined specific value such as 0. The specific value is hereinafter referred to as “non-reception ID”. The specific value is not an ID given to the beacon 500 but is treated as a kind of beacon ID.

Then, the processor 201 controls the communication interface 205 to transmit the generated mobile position information (first mobile position information or second mobile position information). The mobile position information is received by the communication interface 105 of the positioning server 100. Therefore, the processor 201 functions as an example of a first communication unit that transmits the beacon ID to the positioning server 100 in cooperation with the communication interface 205.

On the other hand, the processor 101 of the positioning server 100 that received the mobile position information stores various information included in the mobile position information in a table Ta.

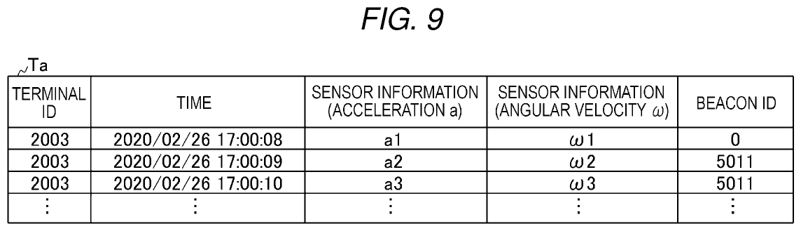

FIG. 9 is a diagram showing an example of the table Ta stored in the auxiliary storage device 104.

In the table Ta, one row corresponds to one piece of mobile position information. Each time the mobile position information is received, the processor 101 adds one row to the table Tb and stores various information included in the mobile body position information. As an example, the table Ta stores the terminal ID, the time, the sensor information, and the beacon ID in association with each other. The sensor information includes, for example, the acceleration and the angular velocity of the mobile terminal device 200. The processor 101 creates one table Ta for each terminal ID. Therefore, all terminal IDs in one table Ta are the same. However, it is also possible to adopt an embodiment in which a plurality of terminal IDs are included in one table.

The processor 101 inputs the terminal ID, time, sensor information, and beacon ID included in the received mobile position information in the row added to the table Ta.

On the other hand, the processor 401 of the moving body terminal device 400 acquires the position information of the moving body terminal device 400, for example, once every predetermined time Ub. The position information includes the position and orientation of the moving body terminal device 400. The position and orientation of the moving body terminal device 400 is also the position and orientation of the moving body 300 including the moving body terminal device 400. The processor 401 acquires the position information of the moving body terminal device 400 by obtaining the position and orientation of the moving body terminal device 400 based on the sensor information acquired from the positioning sensor 406, for example.

The position of the moving body terminal device 400 and the position of the moving body 300 are examples of the first position. The processor 401 functions as a moving body position estimation unit that estimates the position of the moving body 300 by acquiring the position information of the moving body terminal device 400.

On the other hand, the processor 101 of the positioning server 100 that received moving body position information stores various information included in the moving body position information in a table Tb.

FIG. 10 is a diagram showing an example of the table Tb stored in the auxiliary storage device 104. In the table Tb, one row corresponds to one piece of moving body position information. Each time the moving body position information is received, the processor 101 adds one row to the table Tb to store various information included in the moving body position information. As an example, the table Tb stores the terminal ID, the time, and the position information in association with each other. The position information includes, as an example, a coordinate xa and a coordinate ya indicating the position of the moving body terminal device 400, and an orientation θa of the moving body terminal device 400. The processor 101 creates one table Tb for each terminal ID. Therefore, all terminal IDs in one table Tb are the same. However, it is also possible to adopt an embodiment in which a plurality of terminal IDs are included in one table. The coordinates (xa, ya) indicate coordinates on the map, for example. The orientation θa indicates the direction (orientation) on the map.

The processor 101 of the positioning server 100 starts the processing shown in FIGS. 6 to 8 when performing the process of obtaining the position and movement route of the mobile terminal device 200. The processor 101 performs the processing in response to receiving an input instructing to perform the process, for example. The input is, for example, an operation input using the console of the positioning server 100 or the like. Alternatively, the input is a command input to the positioning server 100 from another computer. Alternatively, the input is automatically inputted to the processor 101 by the processor 101 of the positioning server 100 based on a program or the like. The input includes the terminal ID of the mobile terminal device 200 for which the position and the movement route are to be obtained.

The processor 101 allocates a variable IDa, a variable IDb, a variable i, a variable C, a variable ta, and a variable tb to the RAM 103 and the like in the processing shown in FIG. 6. Details of each variable will be described later.

In ACT 41 of FIG. 6, the processor 101 of the positioning server 100 reads the table Ta for the mobile terminal device 200 for which the position and movement route are to be obtained. The terminal ID in the table Ta is the same as the terminal ID of the mobile terminal device 200 for which the position and the movement route are to be obtained. The processor 101 newly creates a table Tc. The table Tc will be described later.

In ACT 42, the processor 101 sets the value of the variable IDa to 0. The variable IDa is a variable indicating the beacon ID. Here, the processor 101 sets the value of the variable IDa to 0 (non-reception ID) for later processing.

In ACT 43, the processor 101 sets the value of the variable C to 0. The variable C is a counter. The variable C indicates how many times the mobile terminal device 200 consecutively received the beacon radio waves of the beacon 500 installed in the moving body 300.

In ACT 43, the processor 101 sets the value of a variable F to False. The variable F is a flag indicating that the position at which the pedestrian H got off the moving body 300 is not stored in the table Tc. The table Tc will be described later.

In ACT 44, the processor 101 sets the value of a variable i to 1. The variable i is a variable indicating which row of the table Ta the processor 101 reads.

In ACT 45, the processor 101 reads the i-th row of the table Ta. The time of the i-th row of the table Ta is referred to as “i-th row time”, and the sensor information of the i-th row of the table Ta is referred to as “i-th row sensor information”.

In ACT 46, the processor 101 substitutes the beacon ID of the row read in ACT 45 for the variable IDb. The variable IDb is a variable indicating the beacon ID of the i-th row of the table Ta.

In ACT 47, the processor 101 determines whether the values of the variable IDa, and the variable IDb are the same. If the values of the variable IDa and the variable IDb are the same, the processor 101 determines Yes in ACT 47 and proceeds to ACT 48.

In ACT 48, the processor 101 determines whether the value of the variable IDb is 0 (non-reception ID). If the value of the variable IDb is 0, the processor 101 determines Yes in ACT 48 and proceeds to ACT 49.

If the value of the variable IDb is not 0, it indicates that the mobile terminal device 200 is receiving radio waves from the beacon 500. That is, the mobile terminal device 200 directly communicates with the beacon 500 wirelessly. Therefore, the processor 101 determines that the beacon ID is not the non-reception ID, and thus functions as a determination unit that determines that the mobile terminal device 200 and the beacon 500 on the moving body 300 can directly communicate with each other wirelessly.

In ACT 49, the processor 101 obtains the position and orientation of the mobile terminal device 200 at the i-th row time by PDR using the i-th row sensor information. The processor 101 also uses the position and orientation stored in the table Tc when obtaining the position and orientation of the mobile terminal device 200 by PDR.

The position of the mobile terminal device 200 is an example of a second position. Therefore, the processor 101 functions as an example of a second acquisition unit that acquires the position of the mobile terminal device 200 by obtaining the position of the mobile terminal device 200.

In ACT 50, the processor 101 stores the position and orientation of the mobile terminal device 200 at the i-th row time obtained in ACT 49, in the table Tc.

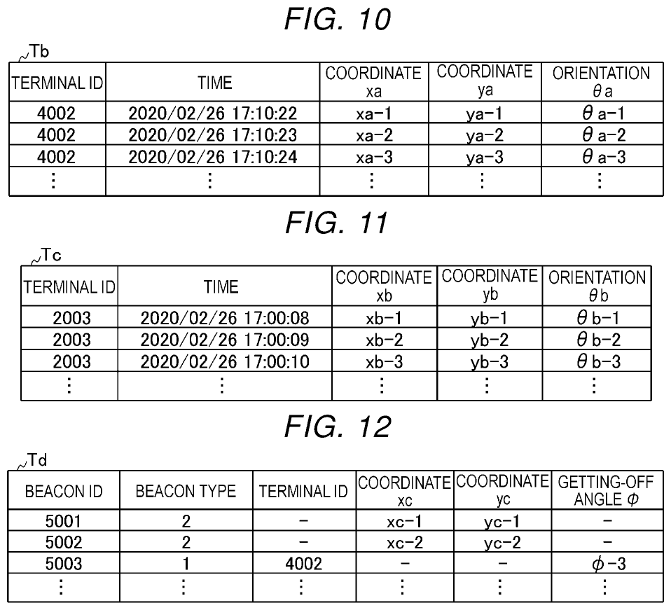

FIG. 11 is a diagram showing an example of the table Tc stored in the auxiliary storage device 104.

The table Tc is a table that stores the position and orientation of the mobile terminal device 200 for each time. As an example, the table Tc stores the terminal ID, the time, and the position information in association with each other. The position information includes a coordinate xb and a coordinate yb indicating the position of the mobile terminal device 200, and an orientation θb of the mobile terminal device 200. The coordinates (xb, yb) indicate coordinates on the map, for example. The orientation θb indicates the direction (orientation) on the map.

On the other hand, if the value of the variable IDb is not 0, the processor 101 determines No in ACT 48 and proceeds to ACT 51.

In ACT 51, the processor 101 increments the value of the variable C by 1.

If the values of the variable IDa and the variable IDb are different, the processor 101 determines No in ACT 47 and proceeds to ACT 52.

In ACT 52, the processor 101 determines whether the value of the variable IDa is 0 (non-reception ID). If the value of the variable IDa is 0, the processor 101 determines Yes in ACT 52 and proceeds to ACT 53.

In ACT 53, the processor 101 sets the value of the variable C to 1.

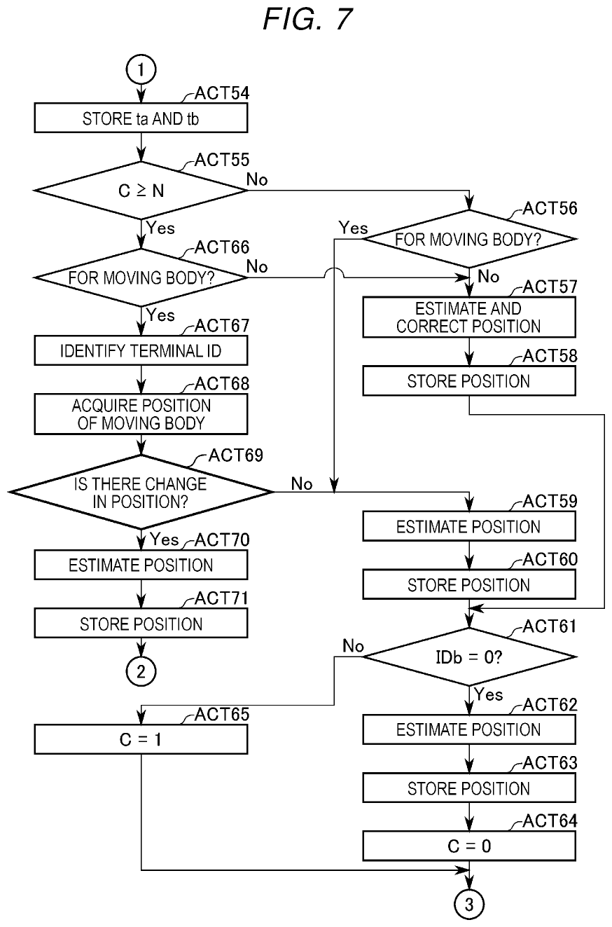

On the other hand, if the value of the variable IDa is not 0, the processor 101 determines No in ACT 52 and proceeds to ACT 54 in FIG. 7.

In ACT 54, the processor 101 stores the time of the (i-C)-th row of the table Ta in the variable ta. Then, the processor 101 stores the time of the (i-1)-th row of the table Ta in the variable tb. The variable ta and the variable tb are variables for storing the time.

In ACT 55, the processor 101 determines whether the value of the variable C is a constant N or more. Here, the value of the variable C indicates how many times the mobile terminal device 200 consecutively received radio waves from the same beacon. Therefore, when the value of the variable C is N or more, it indicates that the mobile terminal device 200 consecutively received radio waves from the same beacon N times or more. The value of the constant N is predetermined by, for example, the designer or the administrator of the position estimation system 1. If the value of the variable C is less than the constant N, the processor 101 determines No in ACT 55 and proceeds to ACT 56.

In ACT 56, the processor 101 determines whether the beacon ID indicated by the variable IDb is that of the beacon 500 installed in the moving body 300. For example, the processor 101 refers to a table Td to identify whether the beacon ID is that of the beacon 500 installed in the moving body 300 or that of the beacon 500 installed in a passage or a road.

FIG. 12 is a diagram showing an example of the table Td stored in the auxiliary storage device 104.

The table Td stores the beacon ID, a beacon type, a terminal ID, a coordinate xc, a coordinate yc, and a getting-off angle θ in association with each other. The beacon type is 1 or 2. The beacon 500 whose beacon type is 1 is the beacon 500 installed in the moving body 300. The beacon 500 whose beacon type is 2 is a beacon 500 installed in a passage or a road. The terminal ID associated with the beacon ID is the terminal ID of the moving body terminal device 400. When the terminal ID is associated with the beacon ID, it indicates that the beacon 500 indicated by the beacon ID, and the moving body terminal device 400 indicated by the terminal ID are installed in the same moving body 300. The beacon ID associated with the terminal ID has a beacon type of 1. The coordinates (xc, yc) indicate the position where the beacon 500 is installed. The beacon ID associated with the coordinates has a beacon type of 2. When the getting-off angle θ is associated with the beacon ID, the getting-off angle θ is an angle that indicates which direction the pedestrian H faces when the pedestrian H gets off the moving body 300 in which the beacon 500 indicated by the beacon ID is installed. The beacon ID associated with the getting-off angle θ has a beacon type of 1.

For example, if the beacon type associated with the beacon ID is 1, the processor 101 refers to the table Td to determine that the beacon ID is that of the beacon 500 installed in the moving body 300. Then, if the beacon type associated with the beacon ID is 2, the processor 101 determines that the beacon ID is not that of the beacon 500 installed in the moving body 300. If the processor 101 determines that the beacon ID indicated by the variable IDb is not that of the beacon 500 installed in the moving body 300, the processor 101 determines No in ACT 56 and proceeds to ACT 57.

In ACT 57, the processor 101 obtains the position and orientation of the mobile terminal device 200 from time to to time tb. The processor 101 uses the sensor information from the (i-C)-th row to the (i-1)-th row of the table Ta to obtain the position and orientation by PDR. The processor 101 corrects the position of the mobile terminal device 200 based on the position of the beacon 500 indicated by the beacon ID of the variable IDb, if necessary. The processor 101 acquires the position of the beacon 500 from the table Td, for example.

However, if the value of the variable F is True, the processor 101 sets the position and orientation of the mobile terminal device 200 at time ta to the position and orientation finally obtained in ACT 72.

In ACT 58, the processor 101 stores the position and orientation of the mobile terminal device 200 from time ta to time tb obtained in ACT 57, in the table Tc.

On the other hand, if it is determined that the beacon ID indicated by the variable IDb is that of the beacon 500 installed in the moving body 300, the processor 101 determines Yes in ACT 56 and proceeds to ACT 59.

In ACT 59, the processor 101 obtains the position and orientation of the mobile terminal device 200 from time ta to time tb, as in ACT 57. However, in ACT 59, the processor 101 does not correct the position of the mobile terminal device 200 based on the position of the beacon 500.

However, if the value of the variable F is True, the processor 101 sets the position and orientation of the mobile terminal device 200 at time ta to the position and orientation finally obtained in ACT 72.

In ACT 60, the processor 101 stores the position and orientation of the mobile terminal device 200 from time ta to time tb obtained in ACT 59, in the table Tc.

The processor 101 proceeds to ACT 61 after the processes of ACT 58 or ACT 60.

In ACT 61, the processor 101 determines whether the value of the variable IDb is 0 (non-reception ID). If the value of the variable IDb is 0, the processor 101 determines Yes in ACT 61 and proceeds to ACT 62.

In ACT 62, the processor 101 obtains the position and orientation of the mobile terminal device 200 at the i-th row time by PDR using the i-th row sensor information.

In ACT 63, the processor 101 stores the position and orientation of the mobile terminal device 200 at the i-th row time obtained in ACT 62, in the table Tc.

In ACT 64, the processor 101 sets the value of the variable C to 0.

On the other hand, if the value of the variable IDb is not 0, the processor 101 determines No in ACT 61 and proceeds to ACT 65.

In ACT 65, the processor 101 sets the value of the variable C to 1.

If the value of the variable C is the constant N or more, the processor 101 determines Yes in ACT 55 and proceeds to ACT 66. The constant N is an arbitrary integer.

In ACT 66, the processor 101 determines whether the beacon ID indicated by the variable IDb is that of the beacon 500 installed in the moving body 300. If the beacon ID indicated by the variable IDb is not that of the beacon 500 installed in the moving body 300, the processor 101 determines No in ACT 66 and proceeds to ACT 57. On the other hand, if the beacon ID indicated by the variable IDb is that of the beacon 500 installed in the moving body 300, the processor 101 determines Yes in ACT 66 and proceeds to ACT 67.

In ACT 67, the processor 101 refers to the table Td to acquire the terminal ID associated with the beacon ID indicated by the variable IDb.

In ACT 68, the processor 101 refers to the table Tb to acquire the position and orientation of the moving body terminal device 400 identified by the terminal ID acquired in ACT 67 from time ta to time tb. The position and orientation are also the position and orientation of the moving body 300 in which the moving body terminal device 400 is installed.

Therefore, the processor 101 functions as an example of a first acquisition unit that acquires the position of the moving body 300 by performing the process of ACT 68. [0091]In ACT 69, the processor 101 determines whether there is a change in the position acquired in ACT 68. The processor 101 determines that there is no change, for example, when the change in the position acquired by ACT 68 is within a predetermined value. The fact that there is no change in the position acquired in ACT 68 indicates that the moving body 300 is stopped. If it is determined that there is no change in the position acquired in ACT 68, the processor 101 determines No in ACT 69 and proceeds to ACT 59. On the other hand, if it is determined that there is a change in the position acquired in ACT 68, the processor 101 determines Yes in ACT 69 and proceeds to ACT 70.

The fact that the processor 101 proceeded to ACT 70 means that the pedestrian H was on the moving body 300 from time ta to time tb. Therefore, the time ta indicates the time when the pedestrian H got on the moving body 300. Time tb indicates the time when the pedestrian H got off the moving body 300.

In ACT 70, the processor 101 obtains the position and orientation of the mobile terminal device 200 from time ta to time tb. That is, the processor 101 considers that the position and orientation of the mobile terminal device 200 from time ta to time tb are the same as the position and orientation acquired in ACT 68. Therefore, the position and orientation of the mobile terminal device 200 from time ta to time tb are the position and orientation acquired in ACT 68.

Therefore, the processor 101 functions as an estimation unit that considers the position of the moving body 300 the position of the mobile terminal device 200 by performing the process of ACT 70.

In ACT 71, the processor 101 stores the position and orientation of the mobile terminal device 200 from time ta to time tb obtained in ACT 70, in the table Tc.

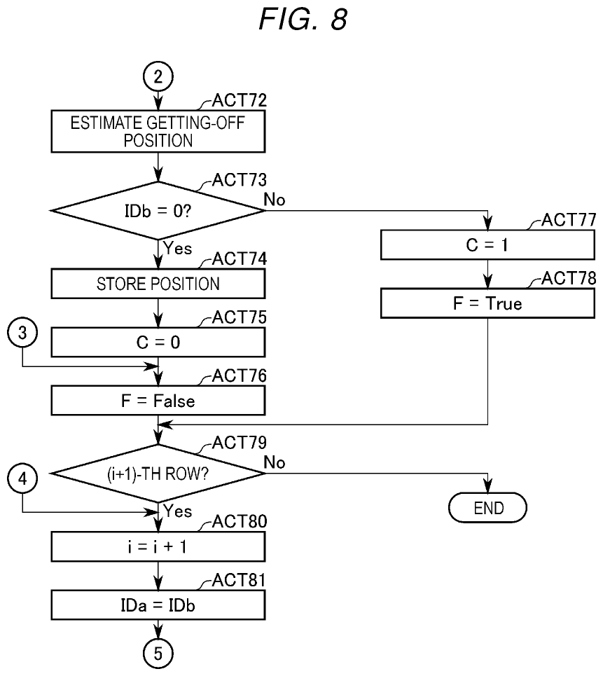

After the process of ACT 71, the processor 101 proceeds to ACT 72 of FIG. 8.

In ACT 72, the processor 101 obtains the position and the orientation in which the pedestrian H got off the moving body 300. The position and orientation are the position and orientation of the mobile terminal device 200 at the i-th row time. The processor 101 obtains the position of the mobile terminal device 200 based on the position and orientation of the mobile terminal device 200 at time tb obtained by ACT 70, for example. The processor 101 acquires, for example, the getting-off angle θ associated with the beacon ID indicated by the variable IDb from the table Td. Then, the processor 101 sets the getting-off angle θ to the orientation of the mobile terminal device 200.

In ACT 73, the processor 101 determines whether the value of the variable IDb is 0 (non-reception ID). If the value of the variable IDb is 0, the processor 101 determines Yes in ACT 73 and proceeds to ACT 74.

In ACT 74, the processor 101 stores the position and orientation of the mobile terminal device 200 obtained in ACT 72 in the table Tc.

In ACT 75, the processor 101 sets the value of the variable C to 0.

After the process of ACT 64 or ACT 65 in FIG. 7 or ACT 75 in FIG. 8, the processor 101 proceeds to ACT 76.

In ACT 76, the processor 101 sets the value of the variable F to False.

On the other hand, if the value of the variable IDb is not 0, the processor 101 determines No in ACT 73 and proceeds to ACT 77.

In ACT 77, the processor 101 sets the value of the variable C to 1.

In ACT 78, the processor 101 sets the value of the variable F to True.

After the process of ACT 76 or ACT 78, the processor 101 proceeds to ACT 79.

In ACT 79, the processor 101 determines whether data exists in the (i+1)-th row in the table Ta. If data exists in the (i+1)-th row in the table Ta, the processor 101 determines Yes in ACT 79 and proceeds to ACT 80. [0103]The processor 101 proceeds to ACT 80 of FIG. 8 after the process of ACT 50, ACT 51, or ACT 53 of FIG. 6.

In ACT 80, the processor 101 increments the value of the variable i by 1.

In ACT 81, the processor 101 substitutes the value of the variable IDb for the variable IDa. After the process of ACT 81, the processor 101 returns to ACT 45 of FIG. 6.

As described above, the processor 101 repeats ACT 45 of FIG. 6 to ACT 81 of FIG. 8 to read from the table Ta row by row and obtain the position and orientation of the mobile terminal device 200 at each time. Then, the processor 101 stores the obtained position and orientation in the table Tc.

Then, if there is no data in the (i+1)-th row in the table Ta, the processor 101 determines No in ACT 79 and ends the processing in FIGS. 6 to 8.

According to the position estimation system 1 of the embodiment, when the mobile terminal device 200 can receive the radio wave transmitted by the beacon 500 installed in the moving body 300, the positioning server 100 considers that the mobile terminal unit 200 is on the moving body 300. Then, when the mobile terminal device 200 is on the moving body 300, the positioning server 100 considers that the position of the moving body 300 is the position of the mobile terminal device 200. As a result, the positioning server 100 of the embodiment can estimate the position of the mobile terminal device 200 while the mobile terminal device 200 is on the moving body 300. Therefore, the positioning server 100 according to the embodiment can estimate the position of the mobile terminal device 200 even when the mobile terminal device 200 does not have a function of estimating the position while riding on the moving body 300. For example, when the mobile terminal device 200 has a function of estimating the position by PDR, the positioning server 100 according to the embodiment can estimate the position of the mobile terminal device 200 even if the position estimation by PDR is not successful while riding on the moving body 300.

If the position of the pedestrian H is estimated using the mobile terminal device 200 while the pedestrian H is on the moving body 300, the position of the pedestrian H may not be properly estimated. For example, there is a possibility that the pedestrian H may be recognized as having moved through the route Rd even though the pedestrian H actually moved riding on the moving body 300 through the route Rc in FIG. 1.

The position estimation system 1 can be used both indoors and outdoors. For example, the position estimation system 1 is used in premises such as a factory, warehouse, or market. Here, for example, a forklift and a turret used in the premises can be used as the moving body 300. As a result, it is possible to track the movement lines of the personnel working on the premises.

According to the position estimation system 1 of the embodiment, when the mobile terminal device 200 cannot receive the radio wave transmitted by the beacon 500 installed in the moving body 300, the positioning server 100 uses the PDR or the like to obtain the position of the mobile terminal device 200. Therefore, the positioning server 100 according to the embodiment can estimate the position of the mobile terminal device 200 even when the mobile terminal device 200 is not on the moving body 300.

According to the position estimation system 1 of the embodiment, the positioning server 100 considers that the mobile terminal device 200 is on the moving body 300 when the mobile terminal device 200 consecutively receives radio waves from the beacon 500 installed in the moving body 300 N times or more. By doing so, the positioning server 100 according to the embodiment prevents from determining that the mobile terminal device 200 is on the moving body 300 when the mobile terminal device 200 passes by the moving body 300.

The above embodiment can be modified as follows.

In the above embodiment, when the mobile terminal device 200 consecutively receives radio waves from the beacon 500 installed in the moving body 300 N times or more, the positioning server 100 considers that the mobile terminal device 200 is on the moving body 300. Similarly, the positioning server 100 may consider that the mobile terminal device 200 landed on the moving body 300 when the mobile terminal device 200 receives radio waves from the beacon 500 consecutively M times or more. M is an arbitrary integer.

The positioning server 100 may display the obtained position and orientation of the mobile terminal device 200 on a display or the like. The positioning server 100 displays, for example, the position and orientation of the mobile terminal device 200 on a map.

The positioning server 100 may also transmit the obtained position and orientation of the mobile terminal device 200 to the mobile terminal device 200 or another device. As a result, devices other than the positioning server 100 can display the position and orientation of the mobile terminal device 200.

The positioning method of the mobile terminal device 200 is not limited to PDR. For example, GNSS such as GPS, an image recognition method using an augmented reality (AR) marker or a natural feature point, or a positioning method using an access point may be used. Since the GNSS cannot be used indoors, the accuracy may decrease while the user is on the moving body 300. The GNSS for pedestrians may have a long update interval, and the accuracy may decrease while the user is on the moving body 300. Positioning using an AR marker or a natural feature point, and a positioning system using an access point are limited in available places. As described above, even when the positioning method other than the PDR is used, the positioning may not be successful while the user is on the moving body 300. Therefore, the position estimation system of the embodiment can obtain the same effect as that of the above embodiments even when the mobile terminal device 200 uses a positioning method other than PDR.

The mobile terminal device 200 may perform part or all of the processes performed by the positioning server 100. Instead of the positioning server 100, the mobile terminal device 200 may perform the position estimation by PDR. In this case, the mobile terminal device 200 transmits the position estimation result instead of the sensor information to the positioning server 100. Then, the positioning server 100 performs each process based on the received position estimation result.

The processor 101, the processor 201, the processor 401, and the processor 501 may realize part or all of the processes realized by the program in the above-described embodiment by a hardware configuration of a circuit.

Each device in the above embodiments is transferred to, for example, an administrator of each device in a state where a program for executing each of the above processes is stored. Alternatively, the respective devices are transferred to the administrator or the like in a state where the program is not stored. Then, the program is separately transferred to the administrator or the like and is stored in each device based on the operation by the administrator or a service person. The transfer of the program at this time can be realized, for example, by using a removable storage medium such as a disk medium or a semiconductor memory, or by downloading via the Internet or LAN.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A position estimation device, comprising:
a first acquisition component configured to acquire a first position of a moving body;
a determination component configured to determine if direct wireless communication is possible between a terminal device and a communication device riding on the moving body; and
an estimation component configured to consider a position of the moving body a position of the terminal device when the direct communication is possible.

2. The position estimation device according to claim 1, further comprising:
a second acquisition component configured to acquire a second position of the terminal device; wherein
the estimation component considers that the terminal device is in the second position when the direct communication is not possible.

3. The position estimation device according to claim 1, wherein
the determining component determines that the direct communication is possible when the terminal device and the communication device consecutively communicate with each other a predetermined number of times or more.

4. The position estimation device according to claim 1, wherein the moving body is a car, ship, or aircraft.

5. The position estimation device according to claim 1, wherein
the moving body comprises a beacon and a moving body terminal device.

6. The position estimation device according to claim 5, wherein
the beacon comprises a processor, a memory, and a transmission-reception circuit.

7. The position estimation device according to claim 1, wherein
the communication device is a smartphone.

8. The position estimation device according to claim 1, wherein
the determination component is further configured to determine if a beacon ID matches a beacon of the moving body.

9. A position estimation system, comprising:
a first terminal device, a second terminal device, a communication device, and a position estimation device, wherein
the first terminal device includes
a receiver configured to receive first identification information transmitted by the communication device, and
a first communication component configured to transmit the first identification information to the position estimation device,
the second terminal device includes
a moving body position estimation component configured to estimate a first position of the moving body, and
a second communication component configured to transmit second identification information for identifying the second terminal device, and the first position,
the communication device includes
a transmission component configured to transmit the first identification information for identifying the communication device, and
the position estimation device includes
a storage component configured to store the first identification information of the second terminal device installed in the moving body and the second identification information of the communication device installed in the moving body in association with each other,
a third communication component configured to receive the first identification information from the first terminal device and receives the second identification information and the first position from the second terminal, and
a position estimation component configured to regard the first position transmitted from the second terminal identified by the second identification information associated with the first identification information as the position of the first terminal.

10. The position estimation system according to claim 9, the first terminal device further comprising:
a second receiver configured to acquire a second position of the communication device; wherein
the moving body estimation component considers that the first terminal device is in the second position when the direct communication is not possible.

11. The position estimation system according to claim 9, further comprising:
a determining component determines that the direct communication is possible when the first terminal device and the second communication device consecutively communicate with each other a predetermined number of times or more.

12. The position estimation system according to claim 9, wherein
the moving body is a car, ship, or aircraft.

13. The position estimation system according to claim 9, wherein
the moving body comprises a beacon and a moving body terminal device.

14. The position estimation system according to claim 13, wherein
the beacon comprises a processor, a memory, and a transmission-reception circuit.

15. The position estimation system according to claim 9, wherein
the first communication component is a smartphone.

16. The position estimation system according to claim 9, wherein
a determination component is further configured to determine if a beacon ID matches a beacon of the moving body.

17. A position estimation method, comprising:
acquiring a first position of a moving body;
determining if direct wireless communication is possible between a terminal device and a communication device riding on the moving body; and
considering that the terminal device is at a position of the moving body when the direct communication is possible.

18. The position estimation method according to claim 17, further comprising:
acquiring a second position of the terminal device; and
considering that the terminal device is in the second position when the direct communication is not possible.

19. The position estimation method according to claim 17, further comprising:
determining that the direct communication is possible when the terminal device and the communication device consecutively communicate with each other a predetermined number of times or more.

20. The position estimation method according to claim 17, further comprising:
determining if a beacon ID matches a beacon of the moving body.
